(19) United States
(12) Patent Application Publication
(10) Pub. No.: US 2004/0225618 A1
(43) Pub. Date: Nov. 11, 2004

(54) Process and system for executing and agreement between a consumer and a provider of services using digital signatures

(76) Inventor: James D. Thackston, Kennesaw, GA (US)

Correspondence Address: McGuireWoods LLP, Suite 1800, 1750 Tysons Boulevard, McLean, VA, 22102, US

(21) Appl. No.: 10/771,138

(22) Filed: Feb. 4, 2004

Related U.S. Application Data
(60) Provisional application No. 60/444,679, filed on Feb. 4, 2003.

(51) Int. Cl. G06F 17/60

(52) U.S. Cl. 705/80

(57) ABSTRACT

The present invention relates to a process and system for executing an agreement between a consumer and a provider of services using digital signature, and, more particularly, to a process and system for executing an agreement between a consumer and a provider of services using digital signature where the agreement exists as in an electronic form combining a request for quotation with all required specifications, instructions, and compliance inspector signature documents.

### CROSS-REFERENCE TO RELATED APPLICATION

This application claims the benefits of provisional U.S. Patent Application No. 60/444,679, filed on Feb. 4, 2003, the disclosure of which is incorporated herein by reference in its entirety, and from co-pending U.S. patent application Ser. No. 10/005,350 filed on Dec. 7, 2001, the contents of which are incorporated be reference herein in its entirety, and which claims from priority from provisional U.S. Patent Application No. 60/251,585, filed on Dec. 7, 2000, the contents of which are incorporated be reference herein in its entirety.

### FIELD OF THE INVENTION

The present invention relates to a process and system for executing an agreement between a consumer and a provider of services using digital signature, and, more particularly, to a process and system for executing an agreement between a consumer and a provider of services using digital signature where the agreement exists as in an electronic form combining a request for quotation with all required specifications, instructions, and compliance inspector signature documents.

### BACKGROUND OF THE INVENTION

In the course of conducting business, companies often seek out many suppliers to provide products and services. Current contracting practice involves the negotiation of complex long-term general contracts. Once general contracts are in place, purchase orders are used for obtaining specific products or services under the term of the general contract.

For some very complex industries such as manufacturing and building construction, the ‘purchase orders’ are themselves very complex in nature. Both of these example industries involve engineering or technical data that suppliers must have when responding to a Request For Quotation (RFQ) or purchase order.

In industries such as manufacturing and construction, general contracts are typically very complex as they attempt to account for a broad variety of contingencies that might arise in the course of a supplier's provisioning of products or services.

One way to describe the current contracting environment is to recognize that the provisioning of a product or service may be naturally very complex. Adding a layer of complexity in the general contract leads to tremendous costs resulting from misunderstanding and even litigation.

If one could efficiently embed all of the necessary contracting elements within an individual RFQ or purchase order, then the need for a complicated general contract is eliminated.

### SUMMARY OF THE INVENTION

An aspect of the present invention provides for improving a request for proposal procedure.

Another aspect of the present invention provides for improving a contracting procedure and acceptance.

To achieve these and other aspects of the present invention, an exemplary embodiment provides a process for contracting for services comprising presenting a service package to at least one vendor for review, where the service package includes at least one of a specification, an instruction and a compliance requirement, receiving a reviewed service package from the at least one vendor, where the at least one of a specification, an instruction and a compliance requirement has been designated as accepted by the vendor, the reviewed service package includes at least one digital signature from the vendor and the reviewed service package includes a bid, and awarding the contract to the vendor.

According to a further exemplary embodiment of the present invention, a system for contracting for services comprises means for presenting a service package to at least one vendor for review, where the service package includes at least one of a specification, an instruction and a compliance requirement, means for receiving a reviewed service package from the at least one vendor, where, the at least one of a specification, an instruction and a compliance requirement has been designated as accepted by the vendor, the reviewed service package includes at least one digital signature from the vendor and the reviewed service package includes a bid, and means for awarding the contract to the vendor.

By way of another exemplary embodiment of the invention, a computer readable medium storing code for controlling a processor to enable for contracting for services, the medium comprises code for presenting a service package to at least one vendor for review, where the service package includes at least one of a specification, an instruction and a compliance requirement, code for receiving a reviewed service package from the at least one vendor, where the at least one of a specification, an instruction and a compliance requirement has been designated as accepted by the vendor, the reviewed service package includes at least one digital signature from the vendor and the reviewed service package includes a bid, and code for awarding the contract to the vendor.

### BRIEF DESCRIPTION OF THE DRAWINGS

The above and other features and advantages of the present invention will become more apparent to those of ordinary skill in the art by describing in detail preferred embodiments thereof with reference to the attached drawings.

FIG. 1 illustrates a work request contract package according to an embodiment of the present invention.

FIG. 2 illustrates a tree graphic according to an embodiment of the present invention.

FIG. 3 illustrates a work request contract package single component layout according to an embodiment of the present invention.

FIG. 4 illustrates a builder screen according to an embodiment of the present invention.

FIG. 5 illustrates a role assignment graphic according to an embodiment of the present invention.

FIG. 6 illustrates a company and employee types graphic according to an embodiment of the present invention.

FIGS. 7A-7F illustrate a customer/vendor/supplier relationship schematic according to an embodiment of the present invention.

FIG. 8 illustrates a part authentication number according to an embodiment of the present invention.

FIG. 9 illustrates a real-time quality assurance process according to an embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

In order to address the ‘dual-complexity’ of current contracting practice, a method may be used that embeds all essential contracting elements within each request for quotation (“RFQ”) which is itself a sub-component of an all encompassing data package containing all specifications, instructions, attributes, graphical and text data that is required by a supplier responding to the needs of a customer.

According to an embodiment of the invention, the present invention describes a process and system for creating, distributing, and managing a comprehensive, self-contained electronic data package that is distributed among a plurality of suppliers. A work request contract package (also referred to as a WRCP or a service package) may use legally binding digital signatures to enable a group of bidding suppliers to consummate a legal contract with the issuer of the WRCP. Once a product has been manufactured or a service has been rendered, digital signatures may then be used by inspectors to ensure that the product or service complies with the specifications and instructions presented in the WRCP.

According to an embodiment of the invention, a WRCP is organized in a tree-like structure whereby data elements including but not limited to term definitions, specifications, instructions, descriptive images, standards, and regulations comprise the branches of the tree. Each data element is assigned a collection of contract line items that in one embodiment are directed to persons responsible for validating the contents of the WRCP, bidding suppliers, and inspectors responsible for verifying compliance.

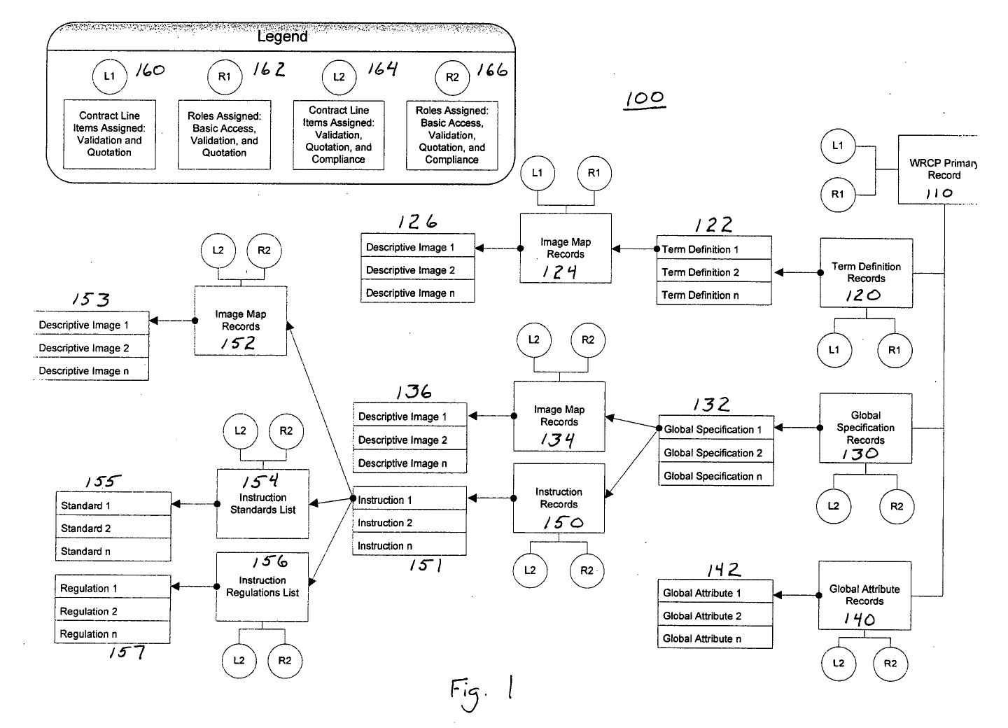

FIG. 1 illustrates a work request contract package according to an embodiment of the present invention. A WRCP tree 100 comprises a primary record 110 which is connected to term definition records 120, global specifications 130 and global attribute records 140. Throughout the WRCP tree 100, various reference is made to contract line item assignments (L1) 160 and (L2) 164 and role assignments (R1) 162 and (R2) 166. As shown in the legend of FIG. 1, contract line item assignment (L1) 160 is for validation and quotation, while contract line item assignment (L2) 164 is for validation, quotation and compliance. Further, role assignment (R1) 162 is for basic access, validation and quotation, while role assignments (R2) 166 is for validation, quotation and compliance.

Term definition records 120 contains one or more term definitions 122, each of which is associated with image map records 124. Image map records 124 contain one or more descriptive images 126. Term definitions may provide a definition of a term used within the WRCP, as well as images used to illustrate and further explain the definition.

Global specification records 130 contains one or more global specifications 132. Each global specification 132 is associated with image map records 134 and instruction records 150. Global specifications may be specifications for performing the service (e.g., tolerances, materials, treatments, etc.). The specifications may have images and instructions associated with them for explanation and illustration. Image map records 134 contain one or more descriptive images 136. Instruction records 150 contain one or more instructions 151. Each instruction 151 is associated with image map records 152, instruction standard list 154 and instruction regulations list 156. Image map records 152 contain one or more descriptive images 153. Instruction standard list 154 contains one or more standards 155. Instruction regulations list 156 contains one or more regulations 156. The instructions may have one or more images associated therewith for purposes of illustration and explanation. Further, instructions may have relevant standards (e.g., industry standards) and regulations (e.g., federal, state, and local laws) associated therewith to provide an explanation. Other structures for a WRCP tree 100 may also be used.

When the RFQ sub-component of a WRCP is activated, a bidding vendor is guided through a structured process whereby contract line items associated with individual data elements are presented and digital signatures are applied. According to an embodiment of the invention, it is during this process that the contract may be consummated. Once the issuer of the WRCP accepts a bid and applies a counter signature, the contract is made with the winner bidder and work may commence.

As one can appreciate, manually creating contracts with this level of resolution would be impractical. A system of roles, company types, and employee types is used to enable the automatic creation of a set of contracts for engaging in business with supply chains of any complexity. Together with the contract line items assigned to each WRCP data element, the system of roles, company types and employee types enable the application of a computer algorithm, included within the scope of the invention, that automatically creates a contract package via a ‘signature table’ whereby companies and employees are filtered and assigned signature records.

For complex projects where many vendors may be involved such as in the construction industry, a general contractor may manage a large group of sub-contractors. The present invention may be used to generate every contract instrument and every inspection document for even the most complex supply chains with a single mouse click.

A similar situation may arise in shipbuilding, building construction or any product industry. Even service industries may involve the collection of inspection signatures to verify compliance with a work request outlined in an RFQ. One important example is in software development. An RFQ may contain line items for software requirements and the post-production inspection will involve the testing results verifying that software requirement line items have been met successfully. In essence, software requirement line items are equivalent to feature specifications found in WRCPs for manufactured parts, buildings, or ships and are well within the scope of the invention.

As illustrated above with reference to FIG. 1, a work request contract package may be an electronic document containing all specifications, instructions, and attributes related to the procurement of a product or service. Associated with each WRCP component and sub-component are one or more contract line items and a set of one or more Roles that logged in users may assume when interacting with the WRCP. The WRCP may use legally binding digital signatures to consummate WRCP contracts across very complex supply chains where several suppliers may be involved in providing the product or service described by the WRCP.

In other words, a WRCP may be the entire contract package that establishes a legal bond between a customer company and its various suppliers for the product or service represented by the WRCP. A practical example might be a manufactured part where several suppliers may be involved in the manufacturing process. A material supplier might provide the raw material, one or more machine shops may shape the material into a functional part, another company may heat-treat the part, and still another company may be contracted to apply a coating to the part.

Another key feature of the WRCP is its ability to control access to its various components. By associating roles to both WRCP components and to employee records in a database, a computer algorithm can be written that ensures that only employees logging in with the proper role can interact with a particular WRCP component. This may be used when digital signatures are applied or when a particular supplier does not have an interest in certain WRCP components characteristics.

The WRCP is also a request for quotation (“RFQ”). Every WRCP component is assigned one quotation role and one quotation contract line item. This allows an employee (bidder) logged in with the quotation role to apply a digital signature to the contract line item which is written in language that asks the bidder if he or she understands the specification, instruction, descriptive image, or other WRCP Component. This feature also permits the issuer of the RFQ (e.g., customer company or procurement management company) to ensure that all bidders completely review the entire RFQ before offering a bid.

Upon acceptance of a bid for an RFQ by the customer company or procurement management company, the customer or procurement management company applies a counter-signature. This makes the contract legally binding and allows the commencement of service rendering.

According to an embodiment of the invention, one or more contract line items may be associated with each WRCP Component. In one embodiment of the invention, a Validation, Quotation, and Compliance CLIN is assigned to every WRCP Component. The Validation CLIN is used to define a contract between the Customer and PMC whereby the Customer verifies, prior to release as an RFQ, that the PMC has properly represented all specifications, instructions, and other WRCP Components. Quotation CLINs are used to define contracts between competitively bidding suppliers and the Customer or PMC. These CLINs make up the key contract for services between winning bidder(s) and the Customer or PMC. When the Customer or PMC has reviewed all bids from involved suppliers, a digital counter-signature is applied to the winning bidder's contract. This is a key innovation whereby the Contract is consummated during a guided, systematic RFQ review process followed by bidding suppliers.

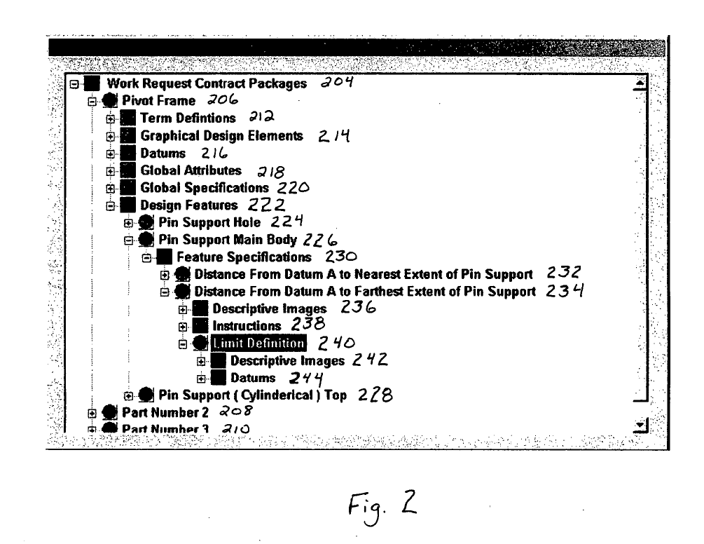

FIG. 2 illustrates a tree graphic according to an embodiment of the present invention. Graphic user interface 200 provides a tree graphic structure 202 for a user to access. In this example, WRCP 204 provides a various part level entries, including pivot frame entry 206, part number two entry 208, and part number three entry 210. It is understood that any number of entries at the part level.

As shown, on a definitions level, pivot frame entry 206 may be accessed by the user and provides term definitions 212, graphical design elements 214, datum 216, global attributes 218, global specifications 220 and design features 222. Again, it is understood that any number of entries at the definitions level.

In the example, illustrated in FIG. 2, a user has accessed design features 222. The design features including information about the pin support hole 224, pin support main body 226 and pin support (cylindrical) top 228. A user may then access any of these specific design features to obtain more information. In this example, pin support main body 226 has been accessed to reveal the feature specifications 230.

Within the feature specifications 230 is the distance from Datum A to nearest extent of Pin Support 232, the distance from Datum A to farthest extent of Pin Support 234. In this example, the distance from Datum A to farthest extent of Pin Support 232 contains descriptive images 236, instructions 238 and limit definitions 240, such as additional descriptive images 242 and datum 244. It is understood that the structure of the tree graphic 202 will change based on the content of the WRCP component, such as the specifications and requirements for the services being requested and the like.

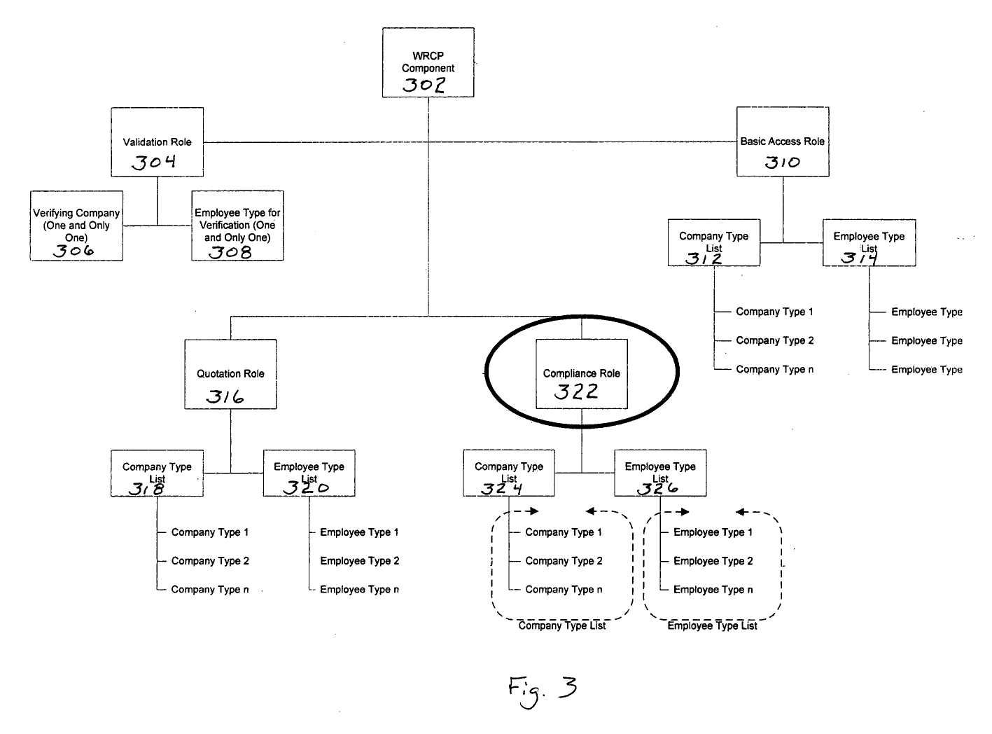

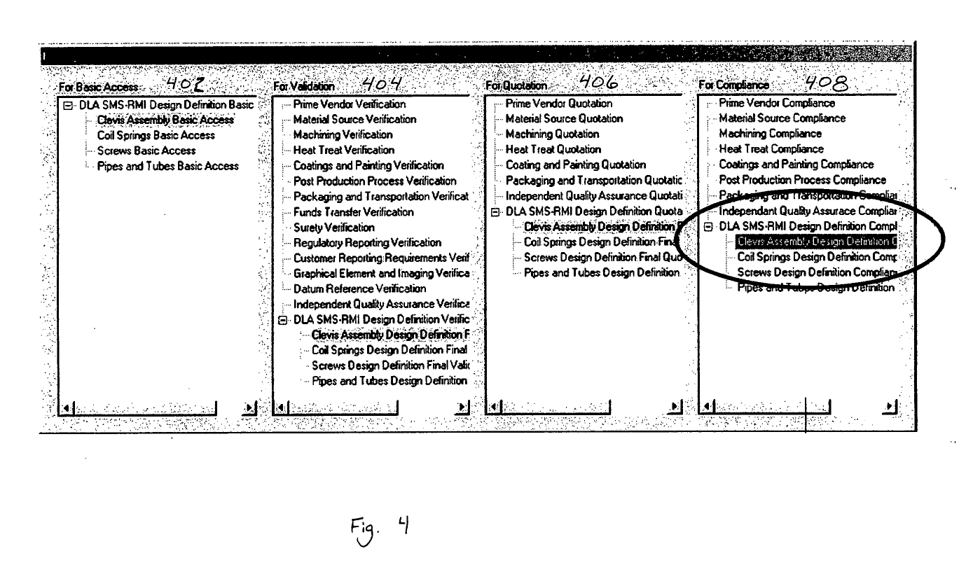

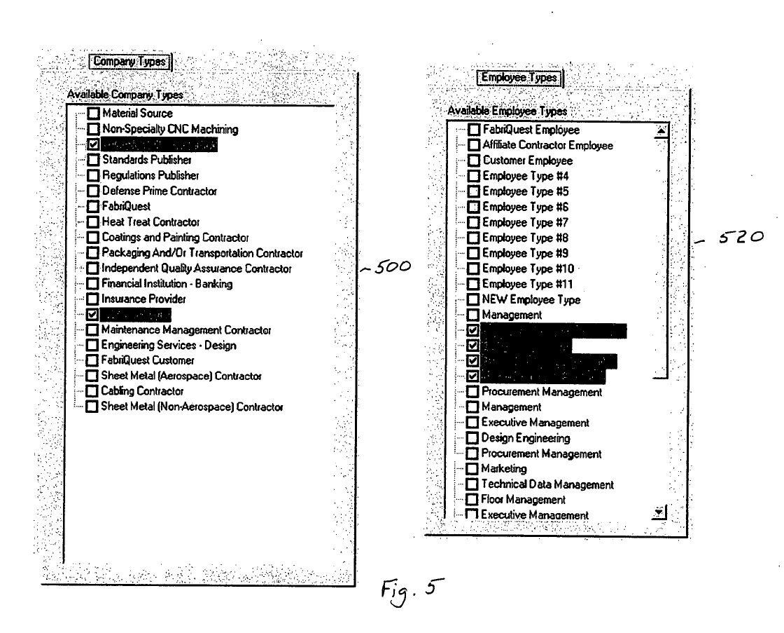

FIG. 3 illustrates a work request contract package single component role layout according to an embodiment of the present invention. In this example, the structure of WRCP component 302 has associated therewith various roles. Validation role 304 has both company verifying 306 and employee type verifying 308. Basic access role 310 includes a company type list 312 and employee type list 314. While company type list 312 is illustrated with three company types and employee type list 314 is illustrated with three employee types, it is understood that any number of company types and employee types may be used.

Quotation role 316 includes company type list 318 and an employee type list 320. While company type list 318 is illustrated with three company types and employee type list 320 is illustrated with three employee types, it is understood that any number of company types and employee types may be used.

Compliance role 322 includes a company type list 324 and an employee type list 326. While company type list 3324 is illustrated with three company types and employee type list 326 is illustrated with three employee types, it is understood that any number of company types and employee types may be used. The various aspects of the compliance role 322 will now be described in greater detail.

FIG. 4 illustrates a role assignment graphic according to an embodiment of the present invention. Graphic user interface 400 presents a basic access menu 402 for basic access role 310, a validation menu 404 for validation role 304, a quotation menu 406 for quotation role 316, and a compliance menu 408 for compliance role 322. With each menu, a user may select a particular part or aspect of the WRCP to assign the appropriate role. In the example illustrated in FIG. 4, the clevis assembly has been highlighted.

FIG. 5 illustrates a company and employee types graphic according to an embodiment of the present invention. Graphic user interface 500 displays a company type list, such as company type list 324. A user may then designate the company types that may access information. In the example of the selection of the clevis assembly, a specialty CNC machining type and a tool vendor type of company have been selected. It is understood that the selections in FIG. 5 are for illustrative purposes only, the other lists may be used based on the services requested.

Graphic user interface 520 displays an employee type list, such as employee type list 326. A user may then designate the employee types that may access information. In the example of the selection of the clevis assembly, executive management, design engineering, design definition engineering and manufacturing engineering have been selected. It is understood that the selections in FIG. 5 are for illustrative purposes only, and that other lists may be used based on the services requested.

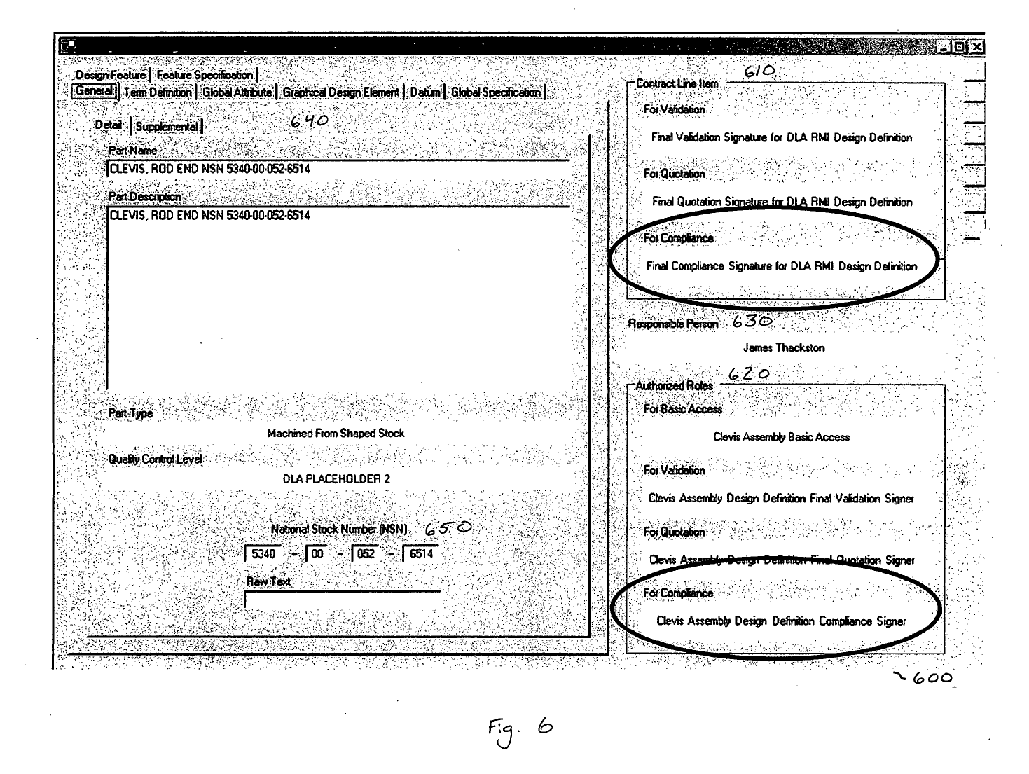

FIG. 6 illustrates a builder screen according to an embodiment of the present invention. Graphic user interface 600 displays an example of a presentation to a user for a particular part and the information associated with that part. Contract Line Item portion 610 provides information about the contract line items for validation, quotation, and compliance. Authorized Role portion 620 provides information about the selected roles for basic access, validation, quotation, and compliance. Responsible Person portion 630 provides information about the person responsible for one or more aspects of the part. General information portion 640 provides general information about a part, such as the part name, the part description, the part type, and the quality control level. Further, general information portion 640 may provide a national stock number 650. Other information may also be provided by graphic user interface 600.

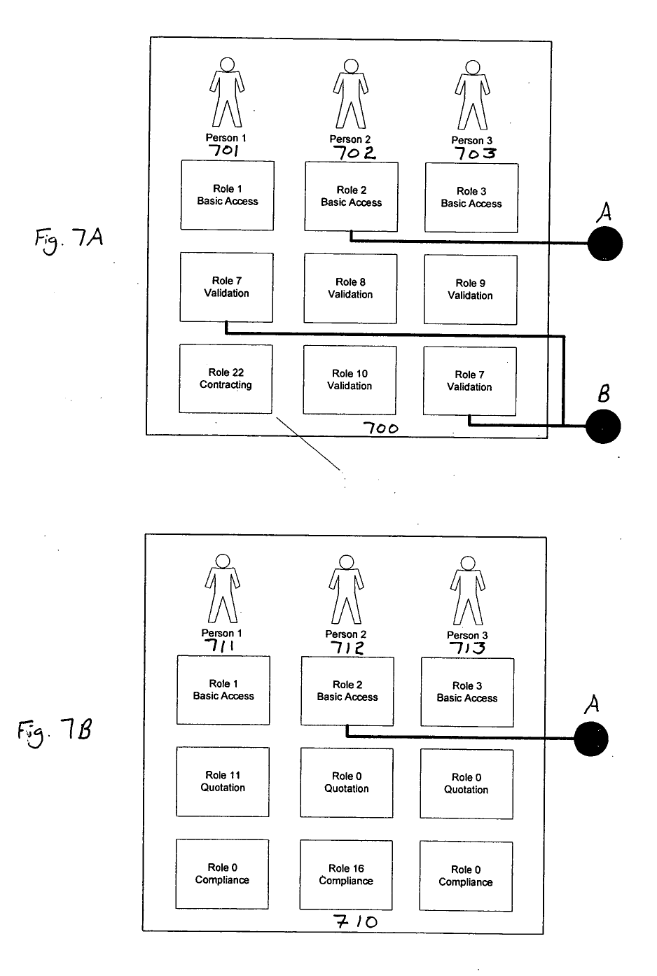

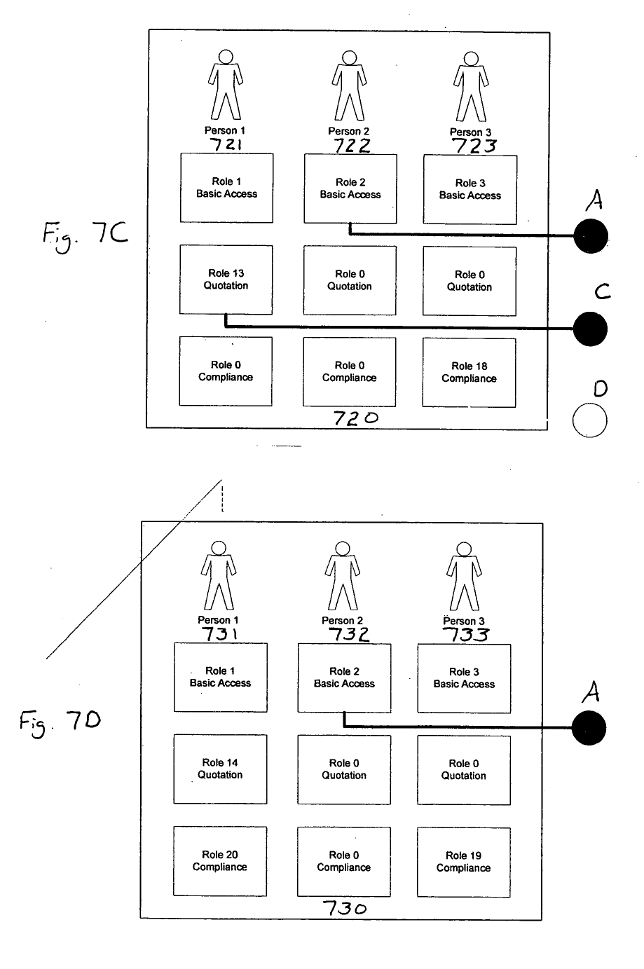

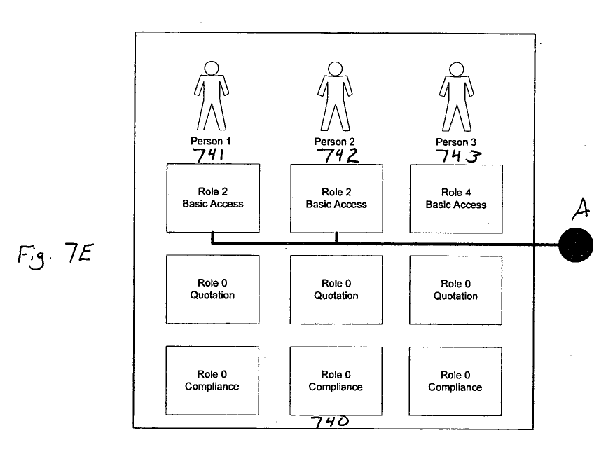

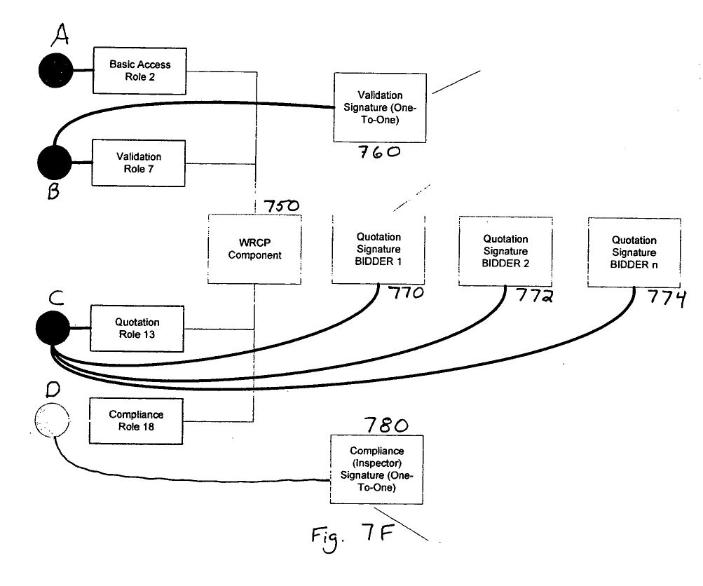

FIGS. 7A-7F illustrate a customer/vendor/supplier relationship schematic according to an embodiment of the present invention. For purposes of explaining these FIGS. 7A-7F, an example of the customer company requiring manufacturing services will be used. However, it is understood that any type of services may be required. According to an embodiment of the invention, every company or entity involved may be assigned one or more company types defining the function(s) that the company may perform in meeting the requirements of one or more WRCPs. Every role assigned to a WRCP component 750 (illustrated in FIG. 7F) may also be assigned one or more company types. The company type list assigned to a role for a WRCP component 750 may restricts the type of company whose employees may interact with the WRCP component 750 in the associated role. This application of company types may be used to facilitate the automatic generation of ‘signature tables’ that define the suite of contracts making up a WRCP.

More specifically, FIG. 7A illustrates a customer company 700 requiring manufacturing services. The customer company 700 has designed a product and wants to outsource its manufacture. In this example, there are three employees Person 1 (701), Person 2 (702), and Person 3 (703). Each is assigned three roles. The assignment of roles determines how the employee may interact with the work request contract package (“WRCP”) component 750 shown in FIG. 7F. For example, Person 1 (701), Person 2 (702), and Person 3 (703) may each be assigned a basic access role, a quotation role, and a compliance role. While the example illustrated in FIG. 7A shows each of Person 1 (701), Person 2 (702), and Person 3 (703) being assigned the same role, it is understood that the people could be assigned different roles. Further, it is also understood that a person could be assigned a different number of roles that three (e.g., one, two, four, etc.).

According to an embodiment of the invention, customer company 700 is the ultimate consumer of services regardless of whether the WRCP is managed by the customer company 700 or the personal management company 740. If the personal management company 740 manages the WRCP, all WRCP components may be validated by any customer company 700 employee logged in with the appropriate validation role. Again, digital signatures may be used during the validation process. According to an embodiment of the invention, a conventional contract exists between the customer company 700 and the personal management company 740. In effect, the personal management company 740 is hired by the customer company 700 to manage procurements using the WRCP concept. The personal management company 740 is discussed in greater detail below with respect to FIG. 7E.

According to an embodiment of the invention, every employee may be assigned one or more employee types defining the function(s) that the employee may perform in meeting the requirements of one or more WRCPs. Every role assigned to a WRCP component 750 is also assigned one or more employee types. The employee type list assigned to a WRCP component 750 role restricts the type of employee that may interact with the WRCP component 750 in the associated role. This application of employee types may be used to facilitate the automatic generation of ‘signature tables’ that define the suite of contracts making up a WRCP.

FIG. 7B shows a materials supplier 710 that has been identified as the supplier of raw materials. In this example, none of the employees have been assigned the quotation role that corresponds to the quotation role assigned to the WRCP component 750 shown in FIG. 7F.

FIG. 7C shows a machining vendor 720. In this example, machining vendor 720 may be qualified to quote on the WRCP and may be asked to consider a specific component within the WRCP. As with company customer 700, Person 1 (721), Person 2 (722) and Person 3 (723) may each be assigned one or more roles within the process.

FIG. 7D shows a heat treat vendor 730. With respect to offering a quote, the WRCP component 750 may govern the information provided to any of the vendors. According to an embodiment of the invention, the system may ensure that for the purposes of quoting, only certain information is presented to a particular bidder. In this example, the heat treat vendor 730 may be permitted to view the content of the illustrated components even though the components are relevant for quoting only to machining vendors. Thus, the heat treat vendor 730 may access information about the type of material to be heat treated, but not information about the quotes of other vendors, including other heat treat vendors. As with company customer 700, Person 1 (731), Person 2 (732) and Person 3 (733) may each be assigned one or more roles within the process.

FIG. 7E shows a procurement management company 740. As with company customer 700, Person 1 (741), Person 2 (742) and Person 3 (743) may each be assigned one or more roles within the process. According to an embodiment of the invention, a third company may manage all WRCP activity on behalf of the customer company 700. In this case, the customer company 700 hires procurement management company 740 to manage procurements using the WRCP concept. According to the example in this configuration, all suppliers accessing a WRCP are suppliers to the procurement management company 740. In other words, the procurement management company 740 is the suppliers' customer rather than the customer company 700. Other arrangements may also be used.

FIG. 7F shows WRCP component 750 in relation to various roles and bidders. WRCP component 750 can be a specification, instruction, attribute, descriptive image, term definition, or any other discrete unit of information that is useful to the customer or supplier company in consummating a contract for services. FIG. 7F highlights the compliance role and its assigned company and company Types. In the example illustrated in FIG. 3, each WRCP Component 750 is assigned a set of four roles and three contract line items. As illustrated, connector E is used to join the compliance example illustrations.

A role describes a behavior-defining attribute assigned to both WRCP components 750 and employees, agents, or representatives. An employee logged in as a particular role may interact in a specified way with all WRCP components 750 assigned that same role. Roles are used to control access and activity. They may also be used to facilitate the automatic generation of ‘signature tables’ that ultimately define the suite of contracts making up a WRCP.

FIG. 7F shows a validation signature 760. According to an embodiment of the invention, the validation signature 760 may be used by qualified engineers or other experts, procurement and quality officials (typically employees of the customer) to ensure and certify the accuracy and completeness of a WRCP before it is released as a request for proposal.

FIG. 7F also shows three bidders, 770, 772 and 774. Each bidder may provide a quotation signature. According to an embodiment of the invention, a quotation signature may be provided to ensure that only employees of companies with a certain functional capability have the ability to review a particular WRCP component 750 for purpose of quoting a bid. For example, a machine shop without hobbing equipment would not be able to review a WRCP component associated with gears for quoting a bid.

Compliance signature 780 may be used once a bid is accepted and the instructions for the WRCP component 750 are in execution. Employees of companies assigned inspection responsibilities may use compliance signature 780 to certify that the instruction for the WRCP component 750 is executed within specification.

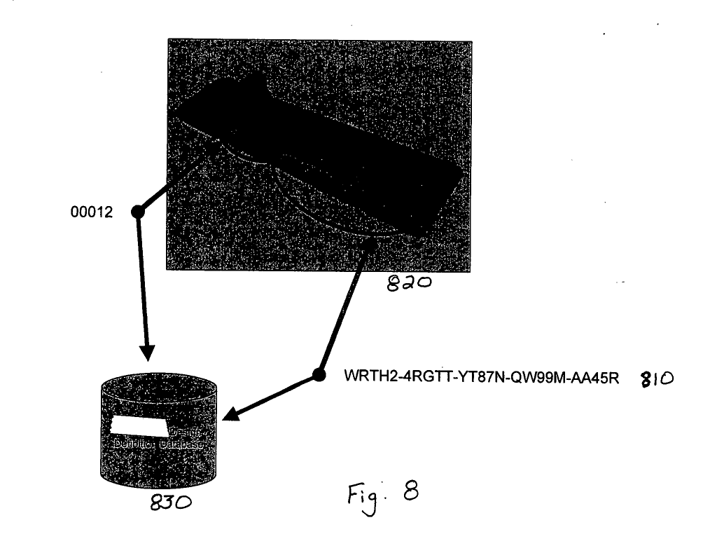

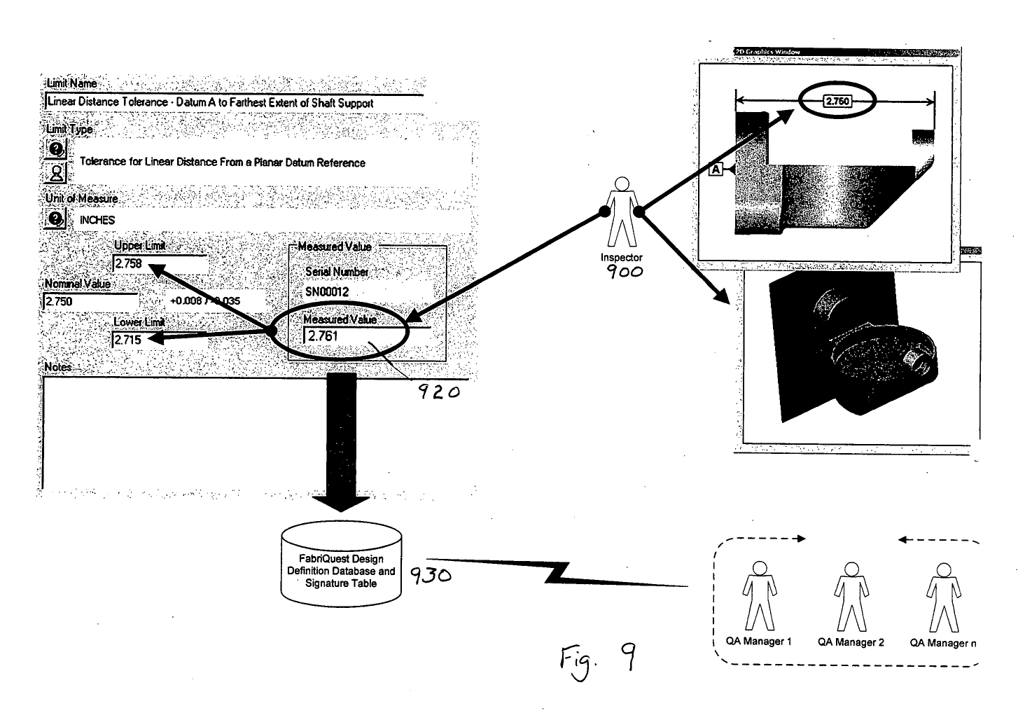

In some cases, products manufactured by a supplier may require the assignment of serial numbers. FIG. 8 illustrates a part authentication number according to an embodiment of the present invention. An authentication number 810, specific to the system may be assigned to each part 820. According to an embodiment of the invention, an authentication number may be a randomly generated combination of at least twelve letter (A-Z) and/or numbers (0-9). The authentication number may compliment a conventional serial number and ensure that every part is procured within the process of the present invention. Every part may be uniquely identified and information may be stored in a design definition database 830. The unique identifier may be used for comprehensive manufacturing traceability. With this invention, a counterfeiter would need to know the specific authentication number of a particular part to cheat the traceability system. Counterfeit products, through inaccurate authentication numbers, may be more easily identified.

Furthermore, certain characteristics of the product features may require inspection and verification such as the diameter of a hole or the placement and condition of a weld. The present invention includes a method for collecting inspector signatures and efficiently associating the signature with both the serial number and the parent WRCP. FIG. 9 illustrates a real-time quality assurance process according to an embodiment of the present invention. An inspector 900, such as an inspector logged in with a proper compliance role, may certify the results of an inspection method used, such as coordinate measuring machine (“CMM”) techniques. Inspector 900 may have access to both two dimensional (“2D”) and three dimensional (“3D”) representations of the measured parameter in a graphical, physical world context.

Inspector 900 may enter measured values into the appropriate entry 920 of graphic user interface 910, and digitally sign the inspection line item. According to an embodiment of the invention, once inspector 900 signs, the value is recorded and rendered unalterable by the inspector 900.

According to an embodiment of the invention, the inspection event may be date and/or time stamped along with an identifier for the inspector 900, and the information and the measured value may be automatically saved in design definition database 930. Further, the measured value may be compared to the specified tolerance limits. If the measured value falls outside of the acceptable limits, appropriate quality assurance managers may be alerted.

According to an embodiment of the present invention, a system may be used for implementing a process disclosed herein. Further, the present invention may be used in connection with various forms of communications of parts. One such system and connection is disclosed in co-pending U.S. patent application Ser. No. 10/005,350 titled “System and Process for Facilitating Efficient Communication of Specifications for Parts and Assemblies with a Mechanism for Assigning Responsibility” by the same inventor, the contents of which are incorporated be reference herein in its entirety. It is understood that the functions described and claimed in the present invention may be performed on the system in the aforementioned patent application by programming the system. Thus, various programming modules within a processor and/or storage device may present a service package to one or more vendors, receive a reviewed service package, evaluate the service package, award a contract to the bidder, determine compliance, store information related to a WRCP and final contract, and the like.

The present invention has been described according to an exemplary embodiment of the invention. As will be understood by one of ordinary skill in the art, various aspects of the invention, including, but not limited to the hardware and software implementation and network requirements are inherent to the description.

According to an embodiment of the invention, the systems and processes described in this invention may be implemented on any general purpose computational device, either as a standalone application or applications, or even across several general purpose computational devices connected over a network and as a group operating in a client-server mode. According to another embodiment of the invention, a computer-usable and writeable medium having a plurality of computer readable program code stored therein may be provided for practicing the process of the present invention. The process and system of the present invention may be implemented within a variety of operating systems, such as, but not limited to, a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system or systems embodying the present invention may comprise computer readable program code in the form of functional instructions stored in the computer-usable medium such that when the computer-usable medium is installed on the system or systems, those components cause the system to perform the functions described. The computer readable program code for the present invention may also be bundled with other computer readable program software. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used. Thus, one or more of the companies described may implement various functions on one or more processors and/or computers. Various roles in the companies may be performed using the processors and/or computers.

According to one specific embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only.

While the invention has been particularly shown and described within the framework of a legal contract and request for quotation, it will be appreciated that variations and modifications can be effected by a person of ordinary skill in the art without departing from the scope of the invention. For example, one of ordinary skill in the art will recognize that certain requests and compliance can be applied to any other transaction-oriented process in which verification and acknowledgement of terms may be used.

What is claimed is:

1. A process for contracting for services comprising:
presenting a service package to at least one vendor for review, where the service package includes at least one of a specification, an instruction and a compliance requirement;
receiving a reviewed service package from the at least one vendor, where:
a) the at least one of a specification, an instruction and a compliance requirement has been designated as accepted by the vendor;
b) the reviewed service package includes at least one digital signature from the vendor; and
c) the reviewed service package includes a bid; and
awarding the contract to the vendor.

2. The process according to claim 1, where the bid includes at least one of a price, an amount of a product to be manufactured, and a date for delivery.

3. The process according to claim 1, where awarding the contract further comprises providing a counter digital signature to create a contract with the vender.

4. The process according to claim 1, where the acceptance of the at least one of a specification, an instruction and a compliance requirement comprises at least one digital signature by an authorized employee of the vender indicating at least one of the of a specification, an instruction and a compliance requirement has been reviewed and understood.

5. The process according to claim 1, wherein:
the service package is presented to a plurality of vendors;
the reviewed service package is received from the plurality of vendors; and
the contract is awarded to one of the plurality of vendors based upon an analysis of the reviewed service contracts received.

6. The process according to claim 5, where awarding the contract to the one of the plurality of vendors further comprises providing a counter digital signature to create a contract with the one of the plurality of vendors.

7. A system for contracting for services comprising:
means for presenting a service package to at least one vendor for review, where the service package includes at least one of a specification, an instruction and a compliance requirement;
means for receiving a reviewed service package from the at least one vendor, where:
a) the at least one of a specification, an instruction and a compliance requirement has been designated as accepted by the vendor;
b) the reviewed service package includes at least one digital signature from the vendor; and
c) the reviewed service package includes a bid; and
means for awarding the contract to the vendor.

8. The system according to claim 7, where the bid includes at least one of a price, an amount of a product to be manufactured, and a date for delivery.

9. The system according to claim 7, where means for awarding the contract further comprises means for providing a counter digital signature to create a contract with the vender.

10. The system according to claim 7, where the acceptance of the at least one of a specification, an instruction and a compliance requirement comprises at least one digital signature by an authorized employee of the vender indicating at least one of the of a specification, an instruction and a compliance requirement has been reviewed and understood.

11. The system according to claim 7, wherein:
the service package is presented to a plurality of vendors;
the reviewed service package is received from the plurality of vendors; and
the contract is awarded to one of the plurality of vendors based upon an analysis of the reviewed service contracts received.

12. The system according to claim 11, where the means for awarding the contract to the one of the plurality of vendors further comprises means for providing a counter digital signature to create a contract with the one of the plurality of vendors.

13. A computer readable medium storing code for controlling a processor to enable for contracting for services, the medium comprising:
code for presenting a service package to at least one vendor for review, where the service package includes at least one of a specification, an instruction and a compliance requirement;
code for receiving a reviewed service package from the at least one vendor, where:
a) the at least one of a specification, an instruction and a compliance requirement has been designated as accepted by the vendor;
b) the reviewed service package includes at least one digital signature from the vendor; and
c) the reviewed service package includes a bid; and
code for awarding the contract to the vendor.

14. The medium according to claim 1, where the bid includes at least one of a price, an amount of a product to be manufactured, and a date for delivery.

15. The medium according to claim 1, where code for awarding the contract further comprises code for providing a counter digital signature to create a contract with the vender.

16. The medium according to claim 1, where the acceptance of the at least one of a specification, an instruction and a compliance requirement comprises at least one digital signature by an authorized employee of the vender indicating at least one of the of a specification, an instruction and a compliance requirement has been reviewed and understood.

17. The medium according to claim 1, wherein:
the service package is presented to a plurality of vendors;
the reviewed service package is received from the plurality of vendors; and
the contract is awarded to one of the plurality of vendors based upon an analysis of the reviewed service contracts received.

18. The medium according to claim 17, where the code for awarding the contract to the one of the plurality of vendors further comprises code for providing a counter digital signature to create a contract with the one of the plurality of vendors.
